(19) United States
(12) Patent Application Publication
(10) Pub. No.: US 2012/0117018 A1
(43) Pub. Date: May 10, 2012

(54) METHOD FOR THE SYSTEMATIC EVALUATION OF THE PROGNOSTIC PROPERTIES OF GENE PAIRS OF MEDICAL CONDITIONS, AND CERTAIN GENE PAIRS IDENTIFIED

(75) Inventors: Lance D. Miller, Singapore (SG); Krishna Murthy Karuturi, Singapore (SG)

(73) Assignee: Agency for Science, Technology and Research, Singapore (SG)

(21) Appl. No.: 13/255,490

(22) PCT Filed: Mar. 10, 2010
(86) PCT No.: PCT/SG2010/000079

§ 371 Date: Sep. 8, 2011

Related U.S. Application Data
(60) Provisional application No. 61/158,948, filed on Mar. 10, 2009.

(51) Int. Cl. G06N 5/04

(52) U.S. Cl. 706/52

(57) ABSTRACT

A method is proposed identification of pairs of genes for which the respective gene expression values in a subject are statistically significant in relation to a medical condition, for example cancer, or more particularly breast cancer. Many pairs of genes are generated, and for each pair of genes clinical data is used to fit a statistical model to obtain the statistical significance of the ratio of the corresponding expression values. The clinical data characterizes for each of the patients the level of expressions of the genes and times until a clinical endpoint of interest.

### FIELD OF THE INVENTION

The present invention relates to identification of pairs of genes for which the respective gene expression values in a subject are statistically significant in relation to a medical condition, for example cancer, or more particularly breast cancer. The gene expression values may for example be indicative of the susceptibility of the subject to the medical condition, or the prognosis of a subject who exhibits the medical condition. The invention further relates to methods and arrays employing the identified gene pairs, and in particular three specific gene pairs obtained by the method, in obtaining information about specific subjects.

### BACKGROUND OF THE INVENTION

Global gene expression profiles of subjects are often used to obtain information about those subjects, such as their susceptibility to certain medical condition, or, in the case of subjects exhibiting medical conditions, their prognosis. For example, having determined that a particular gene is important, the level in which that gene is expressed in a subject can be used to classify the individual into one of a plurality of classes, each class being associated with a different susceptibility or prognosis. An important task is the identification of “significant gene signature(s)”, that is gene set(s) such that the corresponding gene expression values can be such to classify subjects in a useful way.

### 1. The Theory of Survival Analysis

First we will describe briefly the background theory of survival analysis. We denote by T the patient's survival time. T is a continuous non-negative random variable which can take values t, tε[0,∞) T has density function f(t) and cumulative distribution function

$$F ( t ) = P ( T \leq t ) . F ( t ) = {\int }_{0}^{t} f ( {t}^{′} ) d {t}^{′} .$$

We are primarily interested in estimating two quantities:
The survival function: S(t)=P(T>t)=1−F(t)
The hazard function:

$$h ( t ) = \frac{f ( t )}{S ( t )} = {lim}_{Δ t -> 0} \frac{P ( t \leq T < ( t + Δ t ) \vert T \geq t )}{Δ t}$$

The survival function expresses the probability of a patient to be alive at time t. It is often presented in the form S(t)=exp(−H(t)), where

$$H ( t ) = {\int }_{0}^{t} h ( u ) d u$$

denotes the cumulative hazard. The hazard function assesses the instantaneous risk of death at time t, conditional on survival up to that time.

Notice that the hazard function is expressed in terms of the survival function. To this extent, survival distributions and hazard functions can be generated for any distribution defined for tε[0,∞). By considering a random variable W, distributed in (∞,−∞), we can generate a family of survival distributions by introducing location (α) and scale (σ) changes of the form log T=α+σW.

Alternatively, we can express the relationship of the survival distribution to covariates by means of a parametric model. The parametric model employs a “regressor” variable x. Take for example a model based on the exponential distribution and write: log(h(t))=α+βx, or equivalently, h(t)=exp(α+βx).

This is a linear model for the log-hazard, or, equivalently, a multiplicative model for the hazard. The constant α represents the log-baseline hazard (the hazard when the regressor x=0) and the slope parameter β gives the change in hazard rate as x varies. This is an easy example of how survival models can be obtained from simple distributional assumptions. In the next paragraphs we will see more specific examples.

### 2. Cox Proportional Hazards Model

One of the most popular survival models is the Cox proportional hazards model (Cox, 1972):

log h(t)=α(t)+βx (1)

where, as before, t is the survival time, h(t) represents the hazard function, α(t) is the baseline hazard, β is the slope parameter of the model and x is the regressor. The popularity of this model lies in the fact that it leaves the baseline hazard function α(t) (which we may alternatively designate as log h₀(t))
unspecified (no distribution assumed). It can be estimated iteratively by the method of partial likelihood of Cox (1972). The Cox proportional hazards model is semi-parametric because while the baseline hazard can take any form, the covariates enter the model linearly.

Cox (1972) showed that the β coefficient can be estimated efficiently by the Cox partial likelihood function. Suppose that for each of a plurality of K subjects (labelled by k=1, . . . , K), we observe at corresponding time tₖ a certain nominal (i.e. yes/no) clinical event has occurred (e.g. whether there has been metastasis). This knowledge is denoted eₖ. For example eₖ may be 0 if the event has not occurred by time tₖ (e.g. no tumour metastasis at time tₖ) and 1 if the event has occurred (e.g. tumour metastasis at time tₖ). Cox (1972) showed that the β coefficient can be estimated efficiently by the Cox partial likelihood function, estimated as:

$$L ( {β}_{i} ) = {\prod }_{k = 1}^{K} {\{ \frac{exp ( β {x}_{k} )}{{\sum }_{j ∈ R ( {t}_{k} )} exp ( β {x}_{j} )} \}}^{{e}_{k}} \qquad ( 2 )$$

where R(tₖ)={j: =tₖ} is the risk set at time tₖ. Typically, e is a binary variable taking value 0=non-occurrence of the event until time t or 1=occurrence of the event at time t. Later we will discuss a particular case of clinical event we consider in the work, without limiting though our model to this specific case. The likelihood (2) is minimized by Newton-Raphson optimization method for finding successively better approximations to the zeroes (or roots) of a real-valued function, with a very simple elimination algorithm to invert and solve the simultaneous equations.

### 3. The Goodness-of-Split Measure of Survival and Selection of Prognostic Significant Genes

Assume a microarray experiment with i=1, 2, . . . , N genes, whose intensities are measured for k=1, 2, . . . , K breast cancer patients. The log-transformed intensities of gene i and patient k are denoted as y_{i,k}. Log-transformation serves for data “Gaussianization” and variance stabilization purposes, although other approaches, such as the log-linear hybrid transformation of Holder et al. (2001), the generalized logarithm transform of Durbin et al. (2002) and the data-driven Haar-Fisz transform have also been considered in the literature.

Associated with each patient k are a disease free survival time tₖ (in this work DFS time), a nominal clinical event eₖ taking values 0 in the absence of an event until DFS time tₖ or 1 in the presence of the event at DFS time tₖ (DFS event) and a discrete gradual characteristic (histologic grade). Note that in this particular work the events correspond to the presence or absence of tumor metastasis for each of the k patients. Other types of events and/or survival times are possible to be analyzed by the model we will discuss below. Additional information, which is not utilized in this work, includes patients' age (continuous variable ranging from 28 to 93 years old), tumor size (in millimeters), breast cancer subtype (Basal, ERBB2, Luminal A, Luminal B, No subtype, normal-like), patients' ER status (ER+ and ER−) and distant metastasis (a binary variable indicating the presence or absence of distant metastasis).

Assuming, without loss of generality, that the K clinical outcomes are negatively correlated with the vector of expression signal intensity yᵢ of gene i, patient k can be assigned to the high-risk or the low-risk group according to:

$${x}_{k}^{i} = \{ \begin{matrix}1 & ( high - risk ) , if {y}_{i , k} > {c}^{i} \\ 0 & ( low - risk ) , if {y}_{i , k} \leq {c}^{i}\end{matrix} \qquad ( 3 )$$

where cⁱ denotes the predefined cutoff of the ith gene's intensity level. In the case of positive correlation between the K clinical outcomes and yᵢ, patient k is simply assigned to one of the two groups according to:

$${x}_{k}^{i} = \{ \begin{matrix}1 & ( high - risk ) , if {y}_{i , k} \leq {c}^{i} \\ 0 & ( low - risk ) , if {y}_{i , k} > {c}^{i}\end{matrix}$$

After specifying xₖⁱ, the DFS times and events are subsequently fitted to the patients' groups by the Cox proportional hazard regression model:

log hₖⁱ(tₖ|xⁱ,βᵢ)=αᵢ(tₖ)+βᵢxₖⁱ (4)

where, as before, hⁱₖ is the hazard function and aᵢ(tₖ)=log hⁱ₀(tₖ) represents the unspecified log-baseline hazard function for gene i; βᵢ is the regression parameter to be estimated from the model; and tₖ is the patients' survival time. To assess the ability of each gene to discriminate the patients into two distinct genetic classes, the Wald statistic (W) of the at coefficient of model (4) is estimated by minimizing the univariate Cox partial likelihood function for each gene i:

$$L ( {β}_{i} ) = {\prod }_{k = 1}^{K} {\{ \frac{exp ( {β }_{i}^{T} {x}_{k}^{i} )}{{\sum }_{j ∈ R ( {t}_{k} )} exp ( {β }_{i}^{T} {x}_{j}^{i} )} \}}^{{e}_{k}}$$

where R(tₖ)={i:tᵢ=tₖ} is the risk set at time tₖ and eₖ is the clinical event at time tₖ. The actual fitting of model (4) is conducted by the survival package in R (http://cran.r-project.org/web/packages/survival/index.html). The genes with the largest βᵢ Wald statistics (Wᵢ's) or the lowest βᵢ Wald P values are assumed to have better group discrimination ability and thus called highly survival significant genes. These genes are selected for further confirmatory analysis or for inclusion in a prospective gene signature set. Note that given βᵢ, one derives the Wald statistic, W, as:

$$W = \frac{{β}_{i}^{2}}{var ( {β}_{i} )}$$

where

$$var ( {β}_{i} ) = \frac{1}{I ( MLE )}$$

and I denotes the Fisher information matrix of the βᵢ parameter. Estimating the Wald P value, simply requires evaluation of the probability:

$$p - value = Pr ( \frac{{β}_{i}^{2}}{var ( {β}_{i} )} > {χ}_{v}^{2} )$$

where xᵥ² denotes the chi-square distribution with v degrees of freedom.

Typically, v is the number of parameters of the Cox proportional hazards model and in our case v=1. Expression (5) can be derived from the proper statistical tables of the chi-square distribution.

From Eqn. (3) notice that the selection of prognostic significant genes relies on the predefined cut-off value cⁱ that separates the low-risk from the high-risk patients. The simplest cut-off basis is the mean of the individual gene expression values within samples, although other choices (e.g. median, trimmed mean, etc) could be also applied.

### SUMMARY OF THE INVENTION

In general terms, a first aspect of the present invention proposes that, instead of testing the significance of the expression of individual genes individually, many pairs of genes are generated, and for each pair of genes clinical data is used to fit a statistical model to obtain the statistical significance of the ratio of the corresponding expression values. The clinical data characterizes for each of the patients the level of expressions of the genes and times until a clinical endpoint of interest (“survival time”).

Thus, in contrast to the known techniques described above, reliance is not exclusively on linear (or sometimes non-linear) associations between the expression of individual genes and the clinical endpoint of interest. The present invention is motivated by the belief that it is biologically plausible that some genes may by themselves have no strong or obvious statistical correlation with survival, but when put together in a ratio with another gene, particularly one that it interacts with on a biological basis, could result in a “synergistic” correlation with outcome.

One possible expression of this aspect of the invention is a computerized method for identifying one or more pairs of genes, selected from a set of N genes, which are statistically associated with prognosis of a potentially fatal medical condition,

the method employing test data which, for each subject k of a set of K* subjects suffering from the medical condition, indicates (i) a survival time of subject k, and (ii) for each gene i, a corresponding gene expression value y_{i,k} of subject k;
the method comprising:
(i) forming a plurality of pairs of the identified genes (i, j with i≠j), and for each pair of genes:
(a) partitioning the K* subjects into two subsets according to whether log(y_{i,k})−log(y_{j,k}) is respectively above or below a cut-off value c_{i,j};
(b) computationally fitting the corresponding survival times of one of the subsets of the subjects to the Cox proportional hazard regression model, said fitting using a regression parameter β_{i,j}; and
(c) obtaining a significance value indicative of prognostic significance of the gene pair i,j; and
   (ii) identifying one or more of the pairs of genes i,j for which the corresponding significance values have the highest prognostic significance.

The survival time may be an actual survival time (i.e. a time taken to die) or a time spent in a certain state associated with the medical condition, e.g. a time until metastasis of a cancer occurs.

Note that the K* subjects may be a subset of a larger dataset of K (K>K*) subjects. For example, the data for K* subjects can be used as training data, and the rest used for validation.

Alternatively, a plurality of subsets of the K subjects can be defined, and the method defined above is carried out independently for each of the subsets. Each of these subsets of the K subjects is a respective “cohort” of the subjects; if the cohorts do not overlap, they are independent training datasets. Note that each time the method is performed for a certain cohort, K* denotes the number of subjects in that cohort, which may be different from the number of subjects in other of the cohorts. After this, there is a step of discovering which pairs of genes were found to be significant for all the cohorts.

Optionally, there may be one of more further steps of reducing the number of candidate gene pairs, to find the most statistically significant.

Once one or more pairs of significant genes are identified, they can be used to obtain useful information in relation to a certain subject (typically not one of the cohort(s) of subjects) using a statistical model which takes as an input the ratio(s) of the expression values of the corresponding identified pair(s) of genes. The information may for example be susceptibility to the medical condition, the or prognosis (e.g. relating to recurrence or death) of a subject suffering from the condition.

A second aspect of the invention relates to three specific gene pairs which were identified using a method employing gene ratios in relation to breast cancer. These gene pairs are here referred to as:
(i) SEQ ID NO:1 and SEQ ID NO:2;
(ii) SEQ ID NO:3 and SEQ ID NO:4; and
(iii) SEQ ID NO:5 and SEQ ID NO:6.

The gene expression values of one or more of these three pairs of genes are obtained for a subject, the ratio(s) of the expression values of these pair(s) of genes are found, and then the results are entered into a statistical model which takes as an input the ratio(s) of the expression values of the pair(s) of genes, to obtain information about the subject in relation to breast cancer. The information may for example be susceptibility to the medical condition, or prognosis of a subject suffering from the condition.

Based on the same idea, an array may be found for obtaining the gene expressions of at least one (and preferably all) of the three pairs of genes (i)-(iii). Since these three pairs of genes are known to have statistical significance in relation to breast cancer, the array need not additionally be designed to obtain the expression values for a great many other genes, and therefore the array can be manufactured at lower cost than conventional arrays which measure the expression values of hundreds or thousands of other genes. In fact, preferably the present arrays may measure the expression values of no more than 100 genes, or more preferably no more than 20 genes, or even just the three pairs of genes (i) to (iii).

The method, as herein described may be performed with a computer system and/or apparatus. The invention also proposes computer program products (e.g. stored on a tangible recording medium) which are software operable by a computer to cause the computer to perform the computational steps of the method.

Having now generally described the invention, the same will be more readily understood through reference to the following exemplary embodiments which are provided by way of illustration, and are not intended to be limiting of the present invention.

### BRIEF DESCRIPTION OF THE FIGURES

FIG. 1 shows the steps of a first method according to the invention;

FIG. 2 shows the steps of a second method according to the invention;

FIG. 3 illustrates gene expression batch effects and normalizing properties of ratios in the second embodiment;

FIG. 4 illustrates the sum of weights and prognostic group assignment for a 3-ratio model derived in the second embodiment;

FIG. 5, which is composed of FIGS. 5A and 5B, illustrates training and test results of a 3-ratio predictor based on the 3-ratio model; and

FIG. 6, which is composed of FIGS. 6A and 6B, illustrates the Prognostic potential of the 3-ratio predictor using a different subject cohort.

### DEFINITIONS

“Array” or “microarray,” as used herein, comprises a surface with an array, preferably an ordered array, of putative binding (e.g., by hybridization) sites for a sample which often has undetermined characteristics. An array can provide a medium for matching known and unknown nucleic acid molecules based on base-pairing rules and automating the process of identifying the unknowns. An array experiment can make use of common assay systems such as microplates or standard blotting membranes, and can be worked manually, or make use of robotics to deposit the sample. The array can be a macro-array (containing nucleic acid spots of about 250 microns or larger) or a micro-array (typically containing nucleic acid spots of less than about 250 microns).

The term “cut-off” represented by c in the context of the classification, refers to a value for which if the expression level of a particular nucleic acid molecule (or gene) in a subject is above the cut-off, the subject is classified into a first classification group; and if the expression level of the nucleic acid molecule is below or equal to the cut-off, the subject is classified into a second classification group.

The term “gene” refers to a nucleic acid molecule that encodes, and/or expresses in a detectable manner, a discrete product, whether RNA or protein. It is appreciated that more than one nucleic acid molecule may be capable of encoding a discrete product. The term includes alleles and polymorphisms of a gene that encodes the same product or an analog thereof.

### DETAILED DESCRIPTION OF THE INVENTION

Standard molecular biology techniques known in the art and not specifically described were generally followed as described in Sambrook and Russel, Molecular Cloning: A Laboratory Manual, Cold Springs Harbor Laboratory, New York (2001).

### First Embodiment

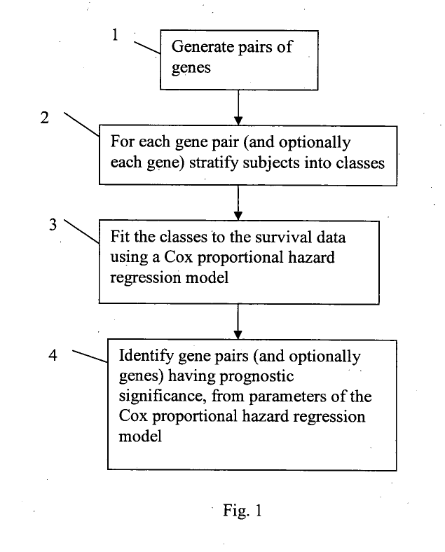

The steps of the method are shown in FIG. 1. The method is carried out using data which, for one or more cohorts of subjects, gives the expression values within tumours of for a large number of genes. For example, it may be carried out using the Affymetrix U133A and B Genechips which consist of about 45,000 probes. A first step of the method (step 1) is to generate a number of pairs of genes. All possible combinations of these genes exceeds 5,000,000 possible combinations.

Label the subjects of one cohort k=1, 2, . . . , K*. For each subject k, there is an expression value y_{i,k} of each of the genes i, and the logarithm of this expression value is given by log y_{i,k}. For each gene and for each of the identified probes, we stratify the subjects (step 2) in the following way. For each gene i and each pair of genes (i, j with i≠j) we define a cut-off parameter cᵢ or c_{i,j} respectively, and define:

$${x}_{k}^{i} = \{ \begin{matrix}1 , & if {y}_{i , k} > {c}^{i} \\ 0 , & if {y}_{i , k} \leq {c}^{i}\end{matrix} and \\ {x}_{k}^{i , j} = \{ \begin{matrix}1 , & if log {y}_{i , k} - log {y}_{j , k} > {c}^{i , j} \\ 0 , & if log {y}_{i , k} - log {y}_{j , k} \leq {c}^{i , j}\end{matrix} \qquad ( 5 )$$

Due to the mathematical identity log A−log B=log(A/B) for any A and B, the cut-off determines according to the ratio of the expression levels y_{i,k} and y_{j,k}.

The values of cᵢ and c_{i,j} may be selected to according to a mean or a median over the cohort.

The significance of each individual gene is then obtained by fitting the survival data to Eqn. (4) above (step 3). The significance of each pair of genes i,j may be determined by fitting the survival data to:

log h^{i,j}ₖ(tₖ|xₖ^{i,j},β_{i,j})=αᵢ(tₖ)+β_{i,j}·xₖ^{i,j}, (6)

We then assess the significance of genes and pairs of genes from the values of βᵢ and β_{i,j} respectively, for example by obtaining p values from a likelihood ratio test or log rank test. The result reflects the prognostic value of a given gene or gene ratio. The more significant the p-value, the greater the gene or gene ratio is associated (in a linear manner) with patient survival. Thus significant pairs of genes, or individual genes, are identified (step 4).

The method of FIG. 1 is performed for multiple comparable clinical patient cohorts, to discriminate true (reproducible) prognostic associations from those resulting from false discovery. That is, we identify the genes and gene pairs which are independently found to be significant for all of the cohorts. Then, in a final independent validation cohort, the prognostic performance of the selected genes or gene ratios is independently evaluated. The intention of this methodology is to identify robust prognostic expression ratios that exceed the prognostic performance of individual genes, and that thus can be used alone or in combination with each other, as well as any other biomarker or other clinical prognostic variable or marker, to enhance patient prognosis.

To test the theory, we targeted a specific clinical entity: early stage (lymph node negative, small tumor diameter) breast cancer. The rationale is that multiple independent cohorts, where the tumor material has been assessed by expression microarrays (namely the Affymatrix U133 platform), and where long term clinical follow-up information is available (i.e. distant metastatis-free survival data), exist and can be utilized for the validation of the methodology. We seek to determine if the gene expression ratios can significantly enhance patient prognosis in this disease type over convention and widely publicized methods involving single gene measurements.

Once significant gene ratios (and optionally also genes) have been identified, they can be used to obtain information relating to specific subjects (e.g. prognosis for those subjects) using measured expression values of those genes in those subjects. This can be done by forming a model (e.g. a Cox proportional hazards model) in which those gene ratios are weighted with values obtained based on a training dataset, and extracting the information from the model, e.g. in the form of diagram indicating survival probability for the subject against time.

Another aspect of this example relates to the biological inferences that can be drawn through further analysis of the “best” prognostic expression ratios. In some instances we expect that the prognostic significance of the gene ratios lies in the ratio's capacity to provide better functional information regarding pathway activity, or other conditional relationships that drive aggressive tumor growth, than individual gene expression levels. Thus, the methodology may lead to the discovery of clinically relevant biological/pathological interactions that could ultimately be therapeutically targetable. Examples of such interactions could be transcription factors/targets, phosphatases/kinases, agonists/antagonists of the same pathway, oncogenes/tumor suppressor genes, etc.

### Second Embodiment

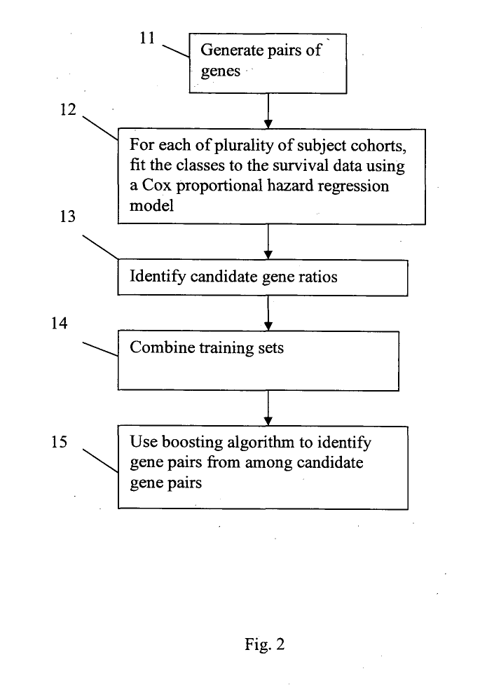

We now present experimental results obtained using 5 cohorts of subjects, referred to here as the Uppsala, Erasmus, Oxford, Stockholm and Transbig cohorts, in a method which is a second embodiment of the invention and illustrated in FIG. 2.

Details of the Erasmus cohort are given in Wang et al. Details of the Oxford cohort are given in Loi et al. Details of the Transbig cohort are given in Desmedt et al.

### 1. Cohort Selection and Processing of Micro-Array Data

This experiment has focused on the clinical entity: LN−, untreated breast cancer. Representing this entity is a large collection of patient data we have assembled that comprises 5 independent patient cohorts totaling 708 cases for which we have corresponding gene expression profiles and clinical annotation. The primary clinical outcome studied was distant metastasis-free survival (i.e., the time interval from initial diagnosis of the primary tumor to distant recurrence, or last follow-up whereby the patient was diagnosed as relapse-free) within a 10-year window.

Each cohort was selected based on compliance with the following 2 clinical criteria: 1) median patient follow-up of at least 5 years, and 2) all patients were treated by surgery with/without local radiation, and without systemic adjuvant (or neo-adjuvant) therapy. Our rationale for selecting node-negative, untreated patients is two-fold. First, that these patients have received no systemic adjuvant therapy ensures that the prognostic associations we discover are not confounded by systemic treatment effects. Second, this subgroup represents early stage breast cancer—for which the decision to treat or not to treat (or how aggressively to treat) is controversial and thus would benefit from better prognostic markers. Clinical characteristics of the cohorts and corresponding reference information are shown in Table 1.

TABLE 1
Clinical and reference information for Patient Subgroup #1.

| | | | | Median | | | |
|---|---|---|---|---|---|---|---|
| Cohort | Systemic | Training/ | # of | Follow-Up | %-age 10-yr | GEO | Literature |
| Name | Therapy | Validation | Patients | (years) | Recurrence | Accession | Reference |
| Uppsala | none | training | 118 | 10.3 | 23.7 | GSE3494 | Miller, et al. (1) |
| Stockholm | none | training | 37 | 5.9 | 51.4 | GSE1456 | Pawitan, et al. (2) |
| OXFU | none | training | 69 | 8.7 | 33.3 | GSE6532 | Loi, et al. (3) |
| EMC | none | training | 286 | 7.2 | 37.4 | GSE2034 | Wang, et al. (4) |
| TBIG | none | validation | 198 | 12.0 | 25.3 | GSE7390 | Desmedt, et al. (5) |

All patient/tumor clinical data were obtained from original published reports or by personal communication with the study leaders. All raw microarray data were downloaded from the NCBI's Gene Expression Omnibus (GEO) via the GEO accession numbers presented in Table 1. All five microarray studies were conducted on the Affymetrix U133A or U133 Plus 2.0 array platforms which contain 22,268 overlapping gene probe sets. Each of the 708 gene array profiles was evaluated for quality according to our previously published methods (Ploner, 2005). All expression profiles were MAS5.0 processed, scaled to a median target intensity of 500 and log₂ transformed. (Post-scaling intensity values<10 were adjusted to 10 in order to prevent negative values after log transformation.) For discovery and validation purposes, the cohorts were divided into training (Uppsala, Stockholm, OXFU, and EMC) and test (TBIG) cohorts.

### 2. Data Formatting and Parallel Computing

Prior to computing the gene ratios, the Affymetrix data were filtered to exclude control probe sets, probe sets that failed to map to human gene sequences with high specificity (Vlad), and probe sets with mean signal intensities of 50 units or less in 2 or more training cohorts. After exclusions, 18,190 probe sets remained for ratio analysis. All possible pair-wise combinations of these probe sets equalled 18190²/2, or 165,438,050 unique gene-pair combinations (step 11 of FIG. 2).

We next analyzed all unique gene-pair combinations, independently, in each of the 4 training cohorts, for statistical correlations with DMFS by Cox Proportional-Hazards Regression (step 12 of FIG. 2). Importantly, standard computing strategies that involve one or several high-performance PCs is insufficient for the timely computation of over a half billion Cox regressions due to physical and virtual memory constraints. Thus, we performed our analysis on Singapore's most powerful super computer. Called the Hilbert Cluster, this system comprises of 500 AMD Opteron processors and can be freely accessed by researchers at the Genome Institute, of Singapore. Using a parallel computing program, we computed the hazard ratios and p-values for ratios representing all gene-pair combinations in each of the 4 training cohorts (i.e., 662 million calculations).

### 3. Selection of Top Gene Ratios for Model Building

Using a data extraction script, the results files output from the Hilbert Cluster were filtered to retain the gene ratios having the following properties: 1) p-value>10-fold more significant than either of the 2 contributing genes (in at least 1 of 4 cohorts), 2) p-value<0.01 in all 4 training cohorts, and 3) consistent directionality (i.e., the ratio must be either positively or negatively correlated with DMFS in all 4 cohorts). In total, we identified 5284 ratios that passed these criteria (step 13 of FIG. 2).

### 4. Training and Testing of Prognostic Models.

To develop prognostic models from the selected gene ratios described above, we first combined all 510 tumor (ratio) profiles from the 4 initial training cohorts into a single “unified” training cohort (step 14 of FIG. 2). Interestingly, the mathematical challenge of combining multiple cohorts into one unified cohort was facilitated by an intrinsic property of gene ratios. In microarray studies, factors that generate artificial signals (noise) in the data (e.g. inconsistent RNA handling procedures, variation in array/reagent batches, fluctuations in scanner laser power, etc) are frequently accounted for and controlled. However, subtle methodological differences between studies can give rise to noise producing “batch effects” that can be observed when identically-processed microarray data from different studies are compared. Batch effects can be recognized by examining the expression distributions of individual genes across studies.

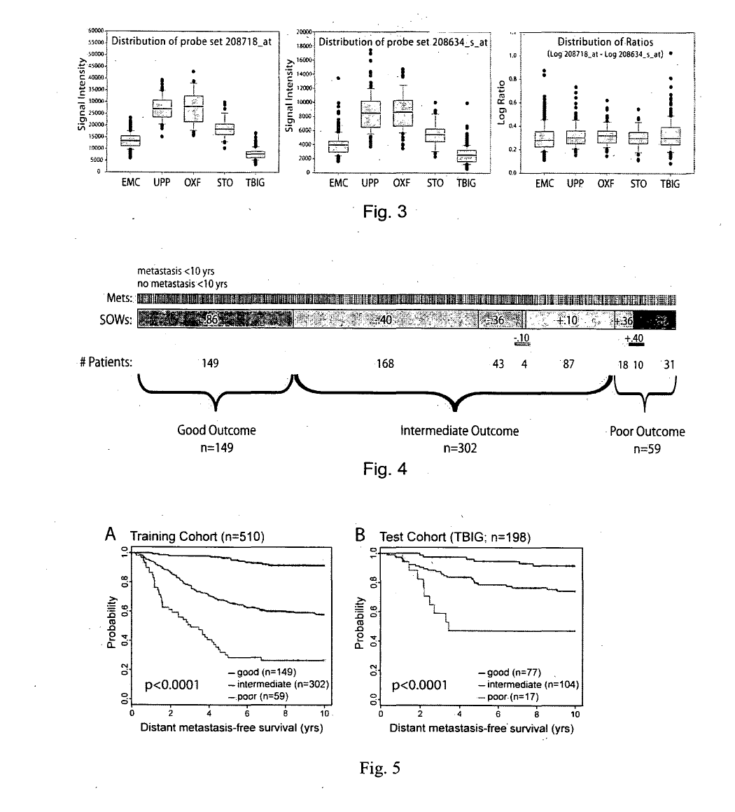

FIG. 3 illustrates gene expression batch effects and normalizing properties of ratios. Left and middle panels show the inequality of expression distributions of two randomly-selected Affymetrix probesets compared across patient cohorts. The log₂ intensities of the two probe sets were converted to ratios, and the resulting “normalized” ratio distributions are shown in the right panel. As shown below in FIG. 3 (left and middle panels), the expression distribution for a given probe set can vary widely across microarray cohorts as the result of batch effects.

However, we have observed that this variation is largely systematic, affecting all gene distributions within a cohort in a similar way. This property is illustrated in the left and middle panels of FIG. 3, where two distinct probe sets, representing high and intermediate expression ranges, display distribution differences that are conserved between cohorts in a relative manner. Because these effects are systematic, transforming the data into gene ratios has a cross-cohort normalizing effect that can be seen in the right panel of FIG. 3, whereby the median ratio within cohorts shows <5% variation across cohorts. Thus, converting expression data to ratios serves to correct cross-cohort batch effects. This batch-correction property of ratios has important implications in model training and testing, as this process operates on the assumption that the distribution pattern of a given linear covariate (e.g., a ratio) is comparable across cohorts.

As our goal was to identify a small number of gene pairs that contribute to prognosis in a synergistic fashion (step 15 of FIG. 2), we developed prognostic models using an ensemble learning algorithm called AdaBoost. Adaboost chooses a collection of features (ie, gene ratios) that can collectively discriminate between classes, for example non-recurrent (−1's) and recurrent cases (1's), in a training set. The process of selecting ratios into the model is iterative, beginning with the ratio that best separates the recurrent and non-recurrent cases. For this “best separator”, a single ratio threshold is identified for the optimal dichotomy of recurrent and non-recurrent cases, and a prognostic weight that reflects the predicted class (positive for 1's negative for −1's) is then applied to each case. Then, the algorithm identifies (from the remaining ratios) the ratio that best complements the ratio that was chosen first. This is done to optimize a scoring function that can be thought of as rewarding the algorithm for making more correct classifications, and also for making progress on cases that were initially misclassified. The third ratio is then chosen based on its ability to complement the first two, and so on. Cases are ultimately classified as “recurrent” or “non-recurrent” by taking a weighted vote over the thresholds computed for each of the chosen ratios. The sign (+/−) of the sum of the weights (SOW) reflects the predicted class of a case, and the magnitude of the SOW reflects the confidence in that prediction. Thus, the SOWs can be viewed as prognostic classes for separating cases (like a recurrence score), where the number of classes is equal to 2^{x}; where x equals the number of ratios in the model.

Typically, in analogous classification procedures, the ideal prognostic model is extrapolated from a feature selection/internal cross-validation strategy to minimize data overfitting and to determine the optimal number of features for inclusion in the model. In our case, however, we used a clinically-guide approach to select a minimal number of ratios for inclusion and to simultaneously define thresholds for “good”, “intermediate” and “poor” outcome categories. FIG. 4 shows the sum of weights and prognostic group assignment for the 3-ratio model. The 3-ratio model applied to the 510 cases of the training cohort gave rise to eight SOW classes from which 3 prognostic groups were defined based on outcome criteria.

Specifically, we asked at what number of ratios in the model can we identify one or more SOW classes that correspond to patients with a distant recurrence rate of <10% at 10 years. The answer, we observed, was 3 or more ratios. With only 3 ratios in the model, the SOW of greatest negative magnitude (−0.86) contained 149 cases which together had a 10-year recurrence rate of only 8.4%—which we subsequently defined as the good outcome group. We then classified the remainder of cases into intermediate and poor outcome groups using SOW thresholds that provided roughly equivalent survival curve separation between the three groups. This can be seen in the Kaplan-Meier plot of FIG. 5A. Shown are survival curves for predicted low, intermediate and poor outcome groups in the training (A) and test (B) cohorts.

To test the prognostic performance of the 3-ratio model in the TBIG cohort, we extracted the expression intensities of the 3 gene pairs, computed their corresponding ratios, and applied the Adaboost thresholds and weights as defined in the model. The resulting good, intermediate and poor outcome groups showed significantly different survival rates (p<0.0001; likelihood ratio test) with the good outcome group having a 10-year recurrence rate of 7.8%—comparable to the training set (FIG. 5B). Notably, in this cohort, while the intermediate and poor outcome groups faired significantly worse than the good outcome group, the rates of recurrence in these groups was less than that observed in the training set, perhaps due to some degree of overfitting, residual batch-effect noise or phenotypic differences between the two cohorts.

With an interest in the reproducibility of each ratio's contribution to the performance of the model, we examined the prognostic potential of each ratio in the TBIG cohort (Table 2). By univariate analysis, we found that all three ratios were significantly correlated with distant recurrence. Moreover, in a multivariate model, each ratio remained significant, suggesting a unique contribution from each ratio to the prognostic power of the 3-ratio predictor.

TABLE 2
Univariate and multivariate analysis of ratios by Cox regression.

| TBIG Cohort | | | | |
|---|---|---|---|---|
| (198 LN-, | Univariate | | Multivariate | |
| untreated) | Hazard Ratio | P- | Hazard Ratio | P- |
| Variables | (95% CI) | value | (95% CI) | value |
| RATIO #1 | 2.89 (1.48-5.66) | 0.002 | 2.42 (1.22-4.76) | 0.01 |
| RATIO #2 | 2.35 (1.29-4.25) | 0.005 | 1.96 (1.06-3.61) | 0.03 |
| RATIO #3 | 2.20 (1.25-3.87) | 0.006 | 1.73 (0.97-3.12) | 0.06 |

5. Comparison of the 3-Ratio Predictor with Conventional Variables.

A primary reason for selecting the TBIG cohort for model testing was its detailed annotation for conventional prognostic markers (including the test results for the 70-gene MammaPrint assay) with which we could compare the prognostic value of our predictor via multivariate analysis. In this cohort, the 3-ratio predictor, tumor size, grade, and ER status were all significantly correlated with DMFS (Table 3). However, when considered in the multivariate model, only the 3-ratio predictor and tumor size remained significant at the 0.05 level, reflecting their unique contributions to prognosis. Furthermore, when considered in the presence of the Mammaprint score, the 3-ratio predictor remained significant, indicating an additive prognostic contribution unique from that of MammaPrint.

TABLE 3
Univariate and multivariate analysis of the 3-ratio predictor and
conventional markers.

| TBIG Cohort | Univariate | | Multivariate | |
|---|---|---|---|---|
| (198 LN-, | Hazard | | Hazard | |
| untreated) | Ratio | | Ratio | |
| Variables | (95% CI) | P-value | (95% CI) | P-value |
| 3-Ratio Score | 2.32 (1.49-3.62) | 0.0004 | 2.08 (1.27-3.40) | 0.004 |
| (1, 2, 3) | | | | |
| Histologic | 1.57 (1.02-2.40) | 0.04 | 0.85 (0.50-1.43) | 0.54 |
| Grade (1, 2, 3) | | | | |
| Tumor size | 1.57 (1.18-2.08) | 0.002 | 1.36 (1.01-1.83) | 0.04 |
| (per 1-cm | | | | |
| increment) | | | | |
| Patient age | 1.02 (0.71-1.48) | 0.9 | 1.02 (0.70-1.47) | 0.92 |
| (per 10-yr | | | | |
| increment) | | | | |
| ER status | 0.43 (0.25-0.75) | 0.003 | 0.53 (0.27-1.02) | 0.06 |
| (+, −) | | | | |
| LN status | NA | NA | NA | NA |
| (all negative) | | | | |
| 3-Ratio Score | 2.32 (1.49-3.62) | 0.0004 | 1.67 (1.01-2.70) | 0.04 |
| (1, 2, 3) | | | | |
| MammaPrint | 7.17 (2.58-19.9) | 0.0002 | 5.46 (1.90-15.7) | 0.002 |
| Score (0, 1) | | | | |

Note that in this embodiment, there is no pre-selection of genes based on survival/prognostic association. Rather, all gene pairs (i.e. ratios) are considered by Cox regression. So the embodiment screens all possible gene combinations (limited only by the number of probes on the microarray) looking for those ratios with the greatest robustness (i.e. reproducible survival associations across 4 independent training datasets, in our example), then we combined all these ratios together into one set, and combined all the tumour samples from the 4 training datasets into one dataset, and asked Adaboost to find the few ratios with the greatest complementarity in predicting outcome (i.e. that work well together in a prognostic model).

### 5. Identity of Top Three Gene Pairs

### Pair #1, Gene #1:

Genbank sequence: NM_{—}006472 (SEQ ID NO: 1)
Affymetrix ID: 201010_s_at
Name: Thioredoxin interacting protein; TXNIP (symbol)
Aliases: VDUP1; Thioredoxin-binding protein 2; Vitamin D3-upregulated protein 1

### Pair #1, Gene #2

Genbank sequence: AI826060 (SEQ ID NO: 2)
Affymetrix ID: 202069_s_at
Name: Isocitrate dehydrogenase 3 (NAD+)alpha: IDH3A (symbol)
Aliases: Isocitrate dehydrogenase 3, alpha subunit

### Pair #2, Gene #1

Genbank sequence: NM_{—}002497 (SEQ ID NO: 3)

### Affymetrix ID: 20464_at

Name: NIMA (never in mitosis gene a)-related kinase 2; NEK2 (symbol)
Aliases: NIMA-related kinase 2

### Pair #2, Gene #2

Genbank sequence: T15766 (SEQ ID NO: 4)

### Affymetrix ID: 213276_at

Name: Calcium/calmodulin-dependent protein kinase (CaM kinase) II beta; CAMK2B (symbol)
Aliases: 2.7.1.123; CAM2; CAMKB; MGC29528; CaM kinase II beta subunit; CaM-kinase II beta chain; proline rich calmodulin-dependent protein kinase

### Pair#3, Gene #1

Genbank sequence: NM_{—}005008 (SEQ ID NO: 5)

### Affymetrix ID: 201076_at

Name: NHP2 non-histone chromosome protein 2-like 1 (S. cerevisiae); NHP2L1 (symbol)
Aliases: NHP2-like protein 1; Non-histone chromosome protein 2, S. cerevisiae, homolog-like 1; U2/U6-15.5K protein

### Pair#3, Gene #2

Genbank sequence NM_{—}022341 (SEQ ID NO: 6)
Affymetrix ID: 219575_s_at
Name: Peptide deformylase (mitochondrial); COG8 (symbol)
Aliases: Transcribed locus, strongly similar to NP_{—}115758.3 component of oligomeric golgi complex 8 [Homo sapiens].

### 6. Validation Data

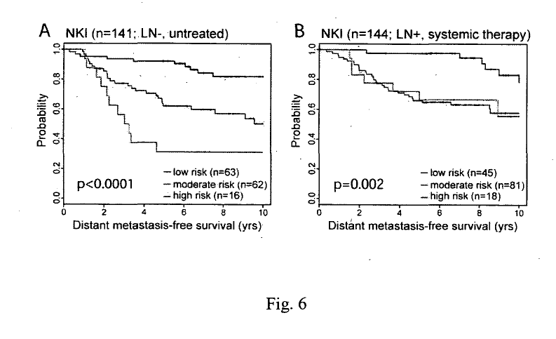

For a final assessment of ratio performance, we analyzed another well known breast cancer microarray cohort from the Netherlands Cancer Institute (NKI). The NKI cohort is comprised of 295 consecutive breast cancer patients with detailed clinical annotation, and the patient samples were profiled on a comprehensive Agilent microarray. Notably, microarray analysis of this cohort enabled the discovery and validation of the 70-gene MammaPrint signature. While the Affymetrix and Agilent microarrays share the ability to detect a large common set of overlapping genes, the probe design algorithms are different, resulting in oligonucleotides of different sequence and length otherwise designed to detect the same genes. Upon accessing this microarray dataset( ) we found that each of our 6 3-ratio predictor genes was represented by at least 1 probe on the Agilent array. In the case of redundant probes, we averaged the expression values to obtain a single value for each gene. Next, we computed the gene ratios, then divided the cohort into 2 subgroups: LN−, untreated (n=141) and LN+ (n=144, >80% were treated with chemotherapy, hormone therapy, or both). Due to technical differences between the array platforms than influence ratio distributions, the 3 ratios were “retrained” by the Adaboost algorithm to identify appropriate thresholds and weights for each ratio. In effect, this optimizes the survival separation achievable by the 3 ratios (and thus could be susceptible to overfitting). While this does not constitute an independent validation of the predictor's performance, it does allow us to evaluate the relative prognostic potential of the 3-ratio predictor in the context of a different gene expression platform (Agilent) and LN+, systemically-treated patients. First, by univariate analysis, we found that each ratio was significantly associated with DMFS by Cox regression in the NKI cohort (p-values: 0.02, 0.006, 0.002, for ratios #1, #2 and #3, respectively). Next, by Kaplan-Meier analysis, we observed a very significant separation between the good, intermediate and poor outcome groups (FIG. 6A) comparable to that observed in the original training and test (TBIG) cohorts.

Using the thresholds and weights determined in the LN− cohort, we then directly tested the 3-ratio predictor on the LN+ NKI cohort. As can be seen in FIG. 6B, the good outcome group maintains a good prognosis (especially for the first 6 years) while the intermediate and poor outcome group survival rates are similar to one another, mimicking that of the LN− intermediate group shown in FIG. 6A. As the majority of patients in the LN+ poor outcome group were systemically treated, the improved outcome in this group (despite the worse prognosis conferred by positive lymph nodes) may indicate a therapeutic benefit for these patients. However, more thorough treatment-control parameters and larger datasets will be needed to ascertain the prognostic and clinical value of gene ratio predictors in the adjuvant setting (this issue is further addressed in the Research Design and Methods section). Together, our observations in the NKI cohort demonstrate the general robustness of the prognostic power of the gene ratios in the context of a different gene-expression detection platform and systemically treated patients.

### REFERENCES

The disclosure of the following documents is hereby incorporated by reference:
Breslow, N. E., “Covariance analysis of censored survival data”, Biometrics, vol. 30, pp 89-99, 1974.
Cox, D. R. and Snell, E. J., “A general definition of residuals (with discussion)”, Journal of the Royal Statistical Society, Series B, vol. 30, pp 248-265, 1968.
Cox R. D. and Oakes, D., Analysis of Survival Data. London: Chapman and Hall, 1984.
Desmedt C, Piette F, Loi S, Wang Y, Lallemand F, Haibe-Kains B, Viale G, Delorenzi M, Zhang Y, d'Assignies M S, Bergh J, Lidereau R, Ellis P, Harris A L, Klijn J G, Foekens J A, Cardoso F, Piccart M J, Buyse M, Sotiriou C; TRANSBIG Consortium. Strong time dependence of the 76-gene prognostic signature for node-negative breast cancer patients in the TRANSBIG multicenter independent validation series. Clin Cancer Res 2007 Jun. 1; 13(11):3207-14.
Efron, B. and Tibshirani, R. J., An Introduction to the Bootstrap. New York: Chapman and Hall, 1994.
Ivshina, A. V., George, J., Senko, O et al, “Genetic reclassification of histologic grade delineates new clinical subtypes of breast cancer”, Cancer Research, vol. 66, pp 10292-10301, 2006.
Kaplan, E. L. and Meier, P., “Nonparametric estimation from incomplete observations”. JASA, vol. 53, 457-48, 1958.
Kuznetsov, V. A., Senko, O. V., Miller, L. D. and Ivshina, A., “Statistically Weighted Voting Analysis of Microarrays for Molecular Pattern Selection and Discovery Cancer Genotypes”, International Journal of Computer Science and Network Security, vol. 6, pp 73-83, 2006.
Loi S, Haibe-Kains B, Desmedt C, Lallemand F, Tutt A M, Gillet C, Ellis P, Harris A, Bergh J, Foekens J A, Klijn J G, Larsimont D, Buyse M, Bontempi G, Delorenzi M, Piccart M J, Sotiriou C. Definition of clinically distinct molecular subtypes in estrogen receptor-positive breast carcinomas through genomic grade. J Clin Oncol. 2007 Apr. 1; 25(10):1239-46.
Loughin, T. M., “A residual bootstrap for regression parameters in proportional hazards model”, J. of Statistical and Computational Simulations, vol. 52, pp 367-384, 1995.
Motakis, E., Nason, G. P., Fryzlewicz, P. and Rutter, G. A., “Variance stabilization and normalization for one-color microarray data using a data-driven multiscale approach”, Bioinformatics, vol. 22, pp 2547-2553, 2006.
Millenaar, F. F., Okyere, J., May, S.T., van Zanten, M., Voesenek, L. A. C. J. and Peters, A. J. M., “How to decide? Different methods of calculating gene expression from short oligonucleotide array data will give different results”, BMC Bioinformatics, vol. 7, no. 137, 2006.
Pawitan, Y., Bjohle, J., Amler, L., at al, “Gene expression profiling spares early breast cancer patients from adjuvant therapy: derived and validated in two population-based cohorts”, Breast Cancer Research, vol. 7, pp R953-R964, 2005.
Wang Y, Klijn J G, Zhang Y, Sieuwerts A M, Look M P, Yang F, Talantov D, Timmermans M, Meijer-van Gelder M E, Yu J, Jatkoe T, Berns E M, Atkins D, Foekens J A. Gene-expression profiles to predict distant metastasis of lymph-node-negative primary breast cancer. Lancet. 2005 Feb. 19-25; 365(9460):671-9.

1. A computerized method for identifying one or more pairs of genes, selected from a set of N genes, which are statistically associated with prognosis of a potentially fatal medical condition,
the method employing test data which, for each subject k of a set of K* subjects suffering from the medical condition, indicates (i) a survival time of subject k, and (ii) for each gene i, a corresponding gene expression value y_{i,k} of subject k;
the method comprising:
(i) forming a plurality of pairs of the identified genes (i, j with i≠j), and for each pair of genes:
(a) partitioning the K* subjects into two subsets according to whether log(y_{i,k})−log(y_{j,k}) is respectively above or below a cut-off value c_{i,j};
(b) computationally fitting the corresponding survival times of one of the subsets of the subjects to the Cox proportional hazard regression model, said fitting using a respective regression parameter β_{i,j}; and
(c) obtaining a significance value indicative of prognostic significance of the gene pair i,j; and
(ii) identifying one or more of the pairs of genes i,j for which the corresponding significance values have the highest prognostic significance.

2. A computerized method according to claim 1, further comprising:
repeating operations (i)-(iii) for one or more additional sets of subjects, thereby identifying for each of said sets of subjects a respective set of gene pairs; and
discovering one or more gene pairs which are in common to the plurality of sets of gene pairs.

3. A computerized method according to claim 2 further comprising verifying the prognostic significance of the discovered gene pairs using data describing the survival times and corresponding gene expression levels of a further set of subjects.

4. A computerized method according to claim 2 further comprising applying a boosting algorithm to select one or more pairs of gene pairs from the gene pairs which are in common to the plurality of sets of gene pairs.

5. A computerized method according to claim 1 wherein the medical condition is cancer, and the expression levels are from samples of respective tumours in the K* subjects.

6. A method according to claim 5 wherein the medical condition is breast cancer.

7. A method according to claim 1 in which the survival time is survival time until mortality.

8. A method according to claim 1 in which the survival time is a survival time without metastasis of a cancer.

9. A computerized method according to claim 1, further comprising:
for each of the one or more identified pairs of genes i, j obtaining corresponding gene expression values yᵢ and yⱼ of a first subject; and
obtaining information about said first subject in relation to said potentially fatal medical condition using a ratio of the obtained gene expression values.

10. A computerized method according to claim 9 in which said information is a prognosis for the first subject who is suffering from the medical condition, a susceptibility of the first subject to the medical condition, a prediction of the recurrence of the medical condition, or a recommended treatment for the medical condition.

11. A method for obtaining information about a first subject in relation to breast cancer, the method comprising:
(a) for each of one or more pairs of genes i, j obtaining corresponding gene expression values yᵢ and yⱼ of the first subject; and
(b) obtaining said information using a ratio of the obtained gene expression values of the pair of genes;
the pairs of genes being selected from the group consisting of:
(i) SEQ ID NO:1 and SEQ ID NO:2;
(ii) SEQ ID NO:3 and SEQ ID NO:4 and
(iii) SEQ ID NO:5 and SEQ ID NO:6.

12. A kit, such as a microarray, for obtaining data for performing prognosis of breast cancer, the microarray being for measuring the expression value of a set of no more than 100 genes, and more preferably no more than 20 genes, comprising at least one of the following pairs of genes:
(i) SEQ ID NO:1 and SEQ ID NO:2;
(ii) SEQ ID NO:3 and SEQ ID NO:4; and
(iii) SEQ ID NO:5 and SEQ ID NO:6.

13. A tangible data storage device storing computer program instructions operative, upon implementation by a processor, to cause the processor to identify one or more pairs of genes, selected from a set of N genes, which are statistically associated with prognosis of a potentially fatal medical condition, by the processor performing the computational operations of:
(i) forming a plurality of pairs of the identified genes (i, j with i≠j),
(ii) for each said pair of genes using test data which, for each subject k of a set of K* subjects suffering from the medical condition, indicates (a) a survival time of subject k, and (b) for each gene i, a corresponding gene expression value y_{i,k} of subject k; to
(a) partition the K* subjects into two subsets according to whether log(y_{i,k})−log(y_{j,k}) is respectively above or below a cut-off value c_{i,j};
(b) computationally fit the corresponding survival times of one of the subsets of the subjects to the Cox proportional hazard regression model, said fitting using a respective regression parameter β_{i,j}; and
(c) obtain a significance value indicative of prognostic significance of the gene pair i,j; and
(iii) identifying one or more of the pairs of genes i,j for which the corresponding significance values have the highest prognostic significance.


SEQUENCE LISTING (6 sequences)

SEQ ID NO: 1 - DNA, 2953 bp, Homo sapiens
atatagagacgtttccgcctcctgcttgaaactaacccctctttttctccaaaggagtgcttgtggagatcggatcttttctccagcaattgggggaaagaaggctttttctctgaattcgcttagtgtaaccagcggcgtatattttttaggcgccttttcgaaaacctagtagttaatattcatttgtttaaatcttattttatttttaagctcaaactgcttaagaataccttaattccttaaagtgaaataattttttgcaaaggggtttcctcgatttggagctttttttttcttccaccgtcatttctaactcttaaaaccaactcagttccatcatggtgatgttcaagaagatcaagtcttttgaggtggtctttaacgaccctgaaaaggtgtacggcagtggcgagaaggtggctggccgggtgatagtggaggtgtgtgaagttactcgtgtcaaagccgttaggatcctggcttgcggagtggctaaagtgctttggatgcagggatcccagcagtgcaaacagacttcggagtacctgcgctatgaagacacgcttcttctggaagaccagccaacaggtgagaatgagatggtgatcatgagacctggaaacaaatatgagtacaagttcggctttgagcttcctcaggggcctctgggaacatccttcaaaggaaaatatgggtgtgtagactactgggtgaaggcttttcttgaccgcccgagccagccaactcaagagacaaagaaaaactttgaagtagtggatctggtggatgtcaatacccctgatttaatggcacctgtgtctgctaaaaaagaaaagaaagtttcctgcatgttcattcctgatgggcgggtgtctgtctctgctcgaattgacagaaaaggattctgtgaaggtgatgagatttccatccatgctgactttgagaatacatgttcccgaattgtggtccccaaagctgccattgtggcccgccacacttaccttgccaatggccagaccaaggtgctgactcagaagttgtcatcagtcagaggcaatcatattatctcagggacatgcgcatcatggcgtggcaagagccttcgggttcagaagatcaggccttctatcctgggctgcaacatccttcgagttgaatattccttactgatctatgttagcgttcctggatccaagaaggtcatccttgacctgcccctggtaattggcagcagatcaggtctaagcagcagaacatccagcatggccagccgaaccagctctgagatgagttgggtagatctgaacatccctgataccccagaagctcctccctgctatatggatgtcattcctgaagatcaccgattggagagcccaaccactcctctgctagatgacatggatggctctcaagacagccctatctttatgtatgcccctgagttcaagttcatgccaccaccgacttatactgaggtggatccctgcatcctcaacaacaatgtgcagtgagcatgtggaagaaaagaagcagctttacctacttgtttctttttgtctctcttcctggacactcactttttcagagactcaacagtctctgcaatggagtgtgggtccaccttagcctctgacttcctaatgtaggaggtggtcagcaggcaatctcctgggccttaaaggatgcggactcatcctcagccagcgcccatgttgtgatacaggggtgtttgttggatgggtttaaaaataactagaaaaactcaggcccatccattttctcagatctccttgaaaattgaggccttttcgatagtttcgggtcaggtaaaaatggcctcctggcgtaagcttttcaaggttttttggaggctttttgtaaattgtgataggaactttggaccttgaacttatgtatcatgtggagaagagccaatttaacaaactaggaagatgaaaagggaaattgtggccaaaactttgggaaaaggaggttcttaaaatcagtgtttcccctttgtgcacttgtagaaaaaaaagaaaaaccttctagagctgatttgatggacaatggagagagctttccctgtgattataaaaaaggaagctagctgctctacggtcatctttgcttaagagtatactttaacctggcttttaaagcagtagtaactgccccaccaaaggtcttaaaagccatttttggagcctattgcactgtgttctcctactgcaaatattttcatatgggaggatggttttctcttcatgtaagtccttggaattgattctaaggtgatgttcttagcactttaattcctgtcaaattttttgttctccccttctgccatcttaaatgtaagctgaaactggtctactgtgtctctagggttaagccaaaagacaaaaaaaattttactacttttgagattgccccaatgtacagaattatataattctaacgcttaaatcatgtgaaagggttgctgctgtcagccttgcccactgtgacttcaaacccaaggaggaactcttgatcaagatgccgaaccctgtgttcagaacctccaaatactgccatgagaaactagagggcaggtcttcataaaagccctttgaacccccttcctgccctgtgttaggagatagggatattggcccctcactgcagctgccagcacttggtcagtcactctcagccatagcactttgttcactgtcctgtgtcagagcactgagctccacccttttctgagagttattacagccagaaagtgtgggctgaagatggttggtttcatgtttttgtattatgtatctttttgtatggtaaagactatattttgtacttaaccagatatatttttaccccagatggggatattctttgtaaaaaatgaaaataaagtttttttaatggaaaaaaaaaaaaaaaaaaaaaaaaaaaa

SEQ ID NO: 2 - DNA, 542 bp, Homo sapiens
  misc_feature (523)..(523): n is a, c, g, or t
atataatgagagatataatttttgttaataagacaaaggtaatatattggatacaaagacacaaatgtattgtgtgttcaattattttgttgtcttgagatttaatattctttccaagagcttttaatgaagcagagagctagtacttcattttcactggatacattttcagcatcatgagttgtcacagcctctgagcccctgatctgaagccagaagggctgagtgtattgtaaacttattcttgcatgttgctgtctgggaatggaccacactacagcaggtagttctgggggcgatactgccgaaaggcccgaacacatgtattttggctgcaattgaggaacttgggatgctattaattttgtatttcagcaactgccccttctcctatcccaaagcaccaattactgccctctgcctcagcagtaccagtataagatgacattccaaagactggaggcaactcagcctgagttaattcacaaaattatgccatgctggggcttgagcttgagcttgngcttaggcttgngctcagc

SEQ ID NO: 3 - DNA, 2130 bp, Homo sapiens
ggttaaacggggcccaaggcaggggtggcgggtcagtgctgctcgggggcttctccatccaggtccctggagttcctggtccctggagctccgcacttggcggcgcaacctgcgtgaggcagcgcgactctggcgactggccggccatgccttcccgggctgaggactatgaagtgttgtacaccattggcacaggctcctacggccgctgccagaagatccggaggaagagtgatggcaagatattagtttggaaagaacttgactatggctccatgacagaagctgagaaacagatgcttgtttctgaagtgaatttgcttcgtgaactgaaacatccaaacatcgttcgttactatgatcggattattgaccggaccaatacaacactgtacattgtaatggaatattgtgaaggaggggatctggctagtgtaattacaaagggaaccaaggaaaggcaatacttagatgaagagtttgttcttcgagtgatgactcagttgactctggccctgaaggaatgccacagacgaagtgatggtggtcataccgtattgcatcgggatctgaaaccagccaatgttttcctggatggcaagcaaaacgtcaagcttggagactttgggctagctagaatattaaaccatgacacgagttttgcaaaaacatttgttggcacaccttattacatgtctcctgaacaaatgaatcgcatgtcctacaatgagaaatcagatatctggtcattgggctgcttgctgtatgagttatgtgcattaatgcctccatttacagcttttagccagaaagaactcgctgggaaaatcagagaaggcaaattcaggcgaattccataccgttactctgatgaattgaatgaaattattacgaggatgttaaacttaaaggattaccatcgaccttctgttgaagaaattcttgagaaccctttaatagcagatttggttgcagacgagcaaagaagaaatcttgagagaagagggcgacaattaggagagccagaaaaatcgcaggattccagccctgtattgagtgagctgaaactgaaggaaattcagttacaggagcgagagcgagctctcaaagcaagagaagaaagattggagcagaaagaacaggagctttgtgttcgtgagagactagcagaggacaaactggctagagcagaaaatctgttgaagaactacagcttgctaaaggaacggaagttcctgtctctggcaagtaatccagaacttcttaatcttccatcctcagtaattaagaagaaagttcatttcagtggggaaagtaaagagaacatcatgaggagtgagaattctgagagtcagctcacatctaagtccaagtgcaaggacctgaagaaaaggcttcacgctgcccagctgcgggctcaagccctgtcagatattgagaaaaattaccaactgaaaagcagacagatcctgggcatgcgctagccaggtagagagacacagagctgtgtacaggatgtaatattaccaacctttaaagactgatattcaaatgctgtagtgttgaatacttggttccatgagccatgcctttctgtatagtacacatgatatttcggaattggttttactgttcttcagcaactattgtacaaaatgttcacatttaatttttctttcttcttttaagaacatattataaaaagaatactttcttggttgggcttttaatcctgtgtgtgattactagtaggaacatgagatgtgacattctaaatcttgggagaaaaaataatgttaggaaaaaaatatttatgcaggaagagtagcactcactgaatagttttaaatgactgagtggtatgcttacaattgtcatgtctagatttaaattttaagtctgagattttaaatgtttttgagcttagaaaacccagttagatgcaatttggtcattaataccatgacatcttgcttataaatattccattgctctgtagttcaaatctgttagctttgtgaaaattcatcactgtgatgtttgtattctttttttttttctgtttaacagaatatgagctgtctgtcatttacctacttctttcccactaaataaaagaattcttcagtt

SEQ ID NO: 4 - DNA, 570 bp, Homo sapiens
  misc_feature (3)..(4): n is a, c, g, or t
ttnngtncgacaccagcacaccgcggacacctagctagcagaccggtgtggcttgctctttaggggtnatgcaaaagaattatcccccagaaaaaaaatccccaaattatcccagacaggcagctccgtggaggtgacaaggtgagagggagaggaggggaggaggccccaggacgccagggtggccggctgctgggccacgtgctgtccgtggtgagccctgccgctgtcccatgncccagngagccactngtgcggagccggcagatgtttaccctgtgttcatggatggggacagctgtcctgggcacagcgtggacggaagatggtgtccactctgagtgttcatcggtggacagtcccctttggagtttaggatcctgtgtccttgttcccattctgtgcccctccctttggcttgaatttntaggggaagataaaggaaatccttgtttgaaaaaaatgtgaatttaaaagtgggcaaggcaattgggcaaggnagcccttaacccttttgagtaaggggttttaaaccaccccaccaaacctgggttaagccacccttgaagc

SEQ ID NO: 5 - DNA, 1601 bp, Homo sapiens
ggagttacgtagaagacagggcgtcctggtgtacgggctggccctggacgtcacttccgctggcggcagtggcgtcacttcctgctcttgggggcggggcatccgtgtccttgcggtgctgggcagcagaccgtccaaaccgacacgcgtggtatcctcgcggtgtccggcaagagactaccaagacagacgctatgactgaggctgatgtgaatccaaaggcctatccccttgccgatgcccacctcaccaagaagctactggacctcgttcagcagtcatgtaactataagcagcttcggaaaggagccaatgaggccaccaaaaccctcaacaggggcatctctgagttcatcgtgatggctgcagacgccgagccactggagatcattctgcacctgccgctgctgtgtgaagacaagaatgtgccctacgtgtttgtgcgctccaagcaggccctggggagagcctgtggggtctccaggcctgtcatcgcctgttctgtcaccatcaaagaaggctcgcagctgaaacagcagatccaatccattcagcagtccattgaaaggctcttagtctaaacctgtggcctctgccacgtgctccctgccagcttcccccctgaggttgtgtatcatattatctgtgttagcatgtagtattttcagctactctctattgttataaaatgtagtactaaatctggtttctggatttttgtgttgtttttgttctgttttacagggttgctatcccccttcctttcctccctccctctgccatccttcatccttttatcctccctttttggaacaagtgttcagagcagacagaagcagggtggtggcaccgttgaaaggcagaaagagccaggagaaagctgatggagccaggacagagatctggttccagctttcagccactagcttcctgttgtgtgcggggtgtggtggaattaaacagcattcattgtgtgtccctgtgcctggcacacagaatcattcatacgtgttcaagtgatcaaggggtttcatttgctcttgggggattaggtatcatttggggaggaagcatgtgttctgtgaggttgttcggctatgtccaagtgtcgtttactaatgtacccctgctgtttgcttttggtaatgtgatgttgatgttctccccctacccacaaccatgcccttgagggtagcagggcagcagcataccaaagagatgtgctgcaggactccggaggcagcctgggtgggtgagccatggggcagttgacctgggtcttgaaagagtcgggagtgacaagctcagagagcatgaactgatgctggcatgaaggattccaggaagatcatggagacctggctggtagctgtaacagagatggtggagtccaaggaaacagcctgtctctggtgaatgggactttctttggtggacacttggcaccagctctgagagcccttcccctgtgtcctgccaccatgtgggtcagatgtactctctgtcacatgaggagagtgctagttcatgtgttctccattcttgtgagcatcctaataaatctgttccattttgatgacaaaaaaaaaaaaaaaaaaaaa

SEQ ID NO: 6 - DNA, 1180 bp, Homo sapiens
ccgggtcactgttaagggggccgccatggcccggctgtggggcgcgctgagtctttggccactgtgggcggccgtgccgtggggcggggcggcagccgtcggtgtccgggcttgcagctccacggccgccccggacggcgtcgagggcccggcgctgcggcgctcctattggcgccacctgaggcgtctggtgctgggtcctcccgaaccgccgttctcgcacgtgtgccaagtcggggacccggtgctgcgcggcgtggcggccccggtggagcgggcgcagctaggcgggcccgagctgcagcggctgacgcaacggctggtccaggtgatgcggcggcggcgctgcgtgggcctaagcgcgccgcagctgggggtgccgcggcaggtgctggcgctggagctccccgaggcgctgtgtcgggagtgcccgccccgccagcgcgcgctccgccaaatggagcccttccccctgcgcgtgttcgtgaaccccagcctgcgagtgcttgacagccgcctggtcacctttcccgagggctgcgagagcgtcgccggcttcctggcctgcgtgccccgcttccaggcggtgcagatctcagggctggaccccaatggagaacaggtggtgtggcaggcgagcgggtgggcagcccgcatcatccagcacgagatggaccacctgcagggctgcctgtttattgacaaaatggacagcaggacgttcacaaacgtctattggatgaaggtgaatgactaaagctttgctactggggctgaggattccggataccaagacgcaaacactttcactttgagctgggcaaatcttacttggcatcaacttggatggctcgcatatgacaggaaactggattgccaaggcatggcagactgagctggaggaagatgtcagaaatgtttgccctgaaatcagttacggacaaaatgttggctacaacttgaggagaaaaatcacccccaaaggagtggacatttcctaacaattctgtatggaggaaggtggggtaattgcattcgtctgcagtagacacgagttcctcggacctgtataatctcccaaagccaaggtttggtaataatgtagtccccaaatacctgaaagctgtctttaaaaatgcaggtaagcatgtgactggcaaaaaaaaaaaaaaaaaaaaaa